(19) United States
(12) Patent Application Publication
(10) Pub. No.: US 2014/0074712 A1
(43) Pub. Date: Mar. 13, 2014

(54) MEDIA DISTRIBUTION SYSTEM AND PROCESS

(71) Applicant: SOUND HALO PTY. LTD., Kew (AU)

(72) Inventors: Barry John Palmer, Kew (AU); Liza Boston, St. Kilda West (AU)

(73) Assignee: SOUND HALO PTY. LTD., Kew (AU)

(21) Appl. No.: 13/794,550

(22) Filed: Mar. 11, 2013

Related U.S. Application Data
(60) Provisional application No. 61/699,061, filed on Sep. 10, 2012.

(51) Int. Cl. G06Q 20/12

(52) U.S. Cl. CPC G06Q 20/1235
USPC 705/44; 705/300; 705/39

(57) ABSTRACT

A media distribution system that records media segments of performances at a live event. The system generates and stores media data files representing respective ones of the recorded segments and segment metadata associated with the respective recorded segments. The system determines if one of the recorded media segments is associated with a user based on the stored metadata and corresponding user data associated with the user, and generates alert data, representing the associated segment, for a client application in a user device associated with the user in the user data, wherein alert data generates an alert in a user interface of the user device. The system receives user response data, generated by the client application, representing a segment ID to identify the associated segment and a response from the user associated with the associated segment.

### CROSS REFERENCE TO RELATED APPLICATION

This application claims the benefit of U.S. Provisional Application No. 61/699,061, filed Sep. 10, 2012, entitled “MEDIA DISTRIBUTION SYSTEM AND PROCESS,” which is incorporated herein in its entirety by reference.

### TECHNICAL FIELD

The present invention relates to systems and processes for media distribution, e.g., for recording, distributing and responding to live music during a concert.

### BACKGROUND

Existing technology can allow the sharing of recordings of live music concerts and other live events, e.g., in the form of “bootleg” compact disks (CDs) after a concert (also referred to as “post curtain call”), or as live feeds (or “streams”) over the World Wide Web.

However, existing technology fails to provide sufficiently fast and convenient access to recordings of individual segments and segments at live events, and sufficient interactivity with the recordings, in particular for concert-goers (who are also referred to as “punters”) at the live event itself, and punters who are sitting at home, using smart phones, tablets, computers and Internet-enabled TV devices (etc.), during the event.

It is desired to address or ameliorate one or more disadvantages or limitations associated with the prior art, or to at least provide a useful alternative.

### SUMMARY

In accordance with the present invention, there is provided a system including:
a recording system configured to record media segments of performances at a live event;
a production system configured to generate:
   media data files representing respective ones of the recorded segments, and
      segment metadata associated with the respective recorded segments;
   a server component configured to:
      receive the media data files and the respective segment metadata from the production system,
      store the media data files in a file store, and
      store the segment metadata in a database;
   an alerting component configured to determine if one of the recorded media segments is associated with a user based on the stored metadata and corresponding user data associated with the user, and generate alert data, representing the associated segment, for a client application in a user device associated with the user in the user data, wherein alert data generates an alert in a user interface (UI) of the user device; and
   a tracking component configured to receive user response data, generated by the client application, representing a segment ID to identify the associated segment and a response from the user associated with the associated segment.

The system can include a delivery component configured to send delivery data to the client application to allow the client application to access the media data file corresponding to the segment ID.

The user response data can include payment data representing a payment request associated with the segment ID, and the tracking component can include a purchasing engine configured to process the payment data to fulfil the payment request; and the delivery component can be configured to send the delivery data only if the purchasing engine generates data indicating that the payment request has been fulfilled.

The purchasing engine can include an e-commerce connector configured to receive payment approval data from an e-commerce server that the payment request has been fulfilled.

The user response data can include payment data representing a payment request associated with the segment ID, and the tracking component can include a purchasing engine configured to process the payment data to fulfil the payment request; and the system can include a merchandising component configured to send merchandise data to the client application representing one or more merchandise items associated with the live event, and the payment data can represent a selected one of the merchandise items.

The tracking component can include a user activity monitoring component configured to store at least a portion of the user response data in the database in association with the segment ID.

The user response data can include ratings data representing a subjective rating of the media data file received through the UI.

The user response data can include sharing data representing transmission of data representing the media data file from the user device to a different user device.

The user response data can include photograph data representing a photograph generated by the client application.

The system can include an authentication component configured to receive authentication permission data from the client application representing permission for the authentication component to access third-party user profile data in a third-party authentication server associated with the user data, and to store the third-party user profile data in the user data.

The alerting component can include an activity feed generation component configured to generate and send activity feed data associated with the live event to the client application of the user if the user is associated with the live event in the stored user data in the database.

The activity feed data can represent stored user data of other friend users who are represented in the stored user data of the user.

The alerting component can include an activity feed generation component configured to generate and send activity feed data associated with a live event to a third-party social media server if the user is associated with the live event in the stored user data in the database.

The system can include a nearby engine configured to receive location data representing locations of user devices and store the location data in the stored user data in association with user identifiers of the user devices.

The alerting component can include an activity feed generation component configured to generate and send activity feed data associated with the live event to the client application of the user if the user is associated with the live event in the stored user data in the database, wherein the association is based on data in the database representing a location of the live event and the stored location data from the nearby engine.

The transmission speed of the media data file to the user device can be independent of a duration of the corresponding segment.

The present invention also provides a process, including the steps of:
recording media segments of performances at a live event;
generating media data files representing respective ones of the recorded segments;
generating segment metadata associated with the respective recorded segments;
determining if one of the recorded media segments is associated with a user based on metadata and corresponding user data associated with the user;
generating alert data, representing the associated segment, for a client application in a user device to generate an alert in a user interface (UI) of the user device, and
receiving user response data generated by the client application representing a segment ID to identify the associated segment and a response from the user associated with the associated segment.

The user response data can include payment data representing a payment request, and the process can include the steps of:
processing the payment data to fulfil the payment request; and
sending delivery data to the client application to access the media data file corresponding to the segment ID.

The step of processing the payment data can include receiving payment approval data from an e-commerce server.

The present invention also provides a media distribution process, including the steps of:
recording media segments of performances at a live event;
generating media data files representing respective ones of the recorded segments;
generating segment metadata representing a segment record for recorded segment;
selecting at least one from a plurality application clients, represented by user record data, based on selection criteria in the user record data matching data in the segment record; and
sending data representing the media data file to the selected application client.

### BRIEF DESCRIPTION OF THE DRAWINGS

Preferred embodiments of the present invention are hereinafter further described, by way of example only, with reference to the accompanying drawings, in which:

FIG. 1 is a block diagram of an embodiment of a media distribution system;

FIG. 2 is a block diagram of an application server of the media distribution system;

FIG. 3 is a block diagram of an Internet configuration of the media distribution system;

FIG. 4 is a schematic diagram of an edge-server configuration of the media distribution system;

FIGS. 5A-5H are diagrams of user-interface objects and connections in a user interface of user devices of the media distribution system; and

FIG. 6 is a block diagram showing synchronisation of segment data between user devices in the media distribution system.

### DETAILED DESCRIPTION

### Media Distribution System

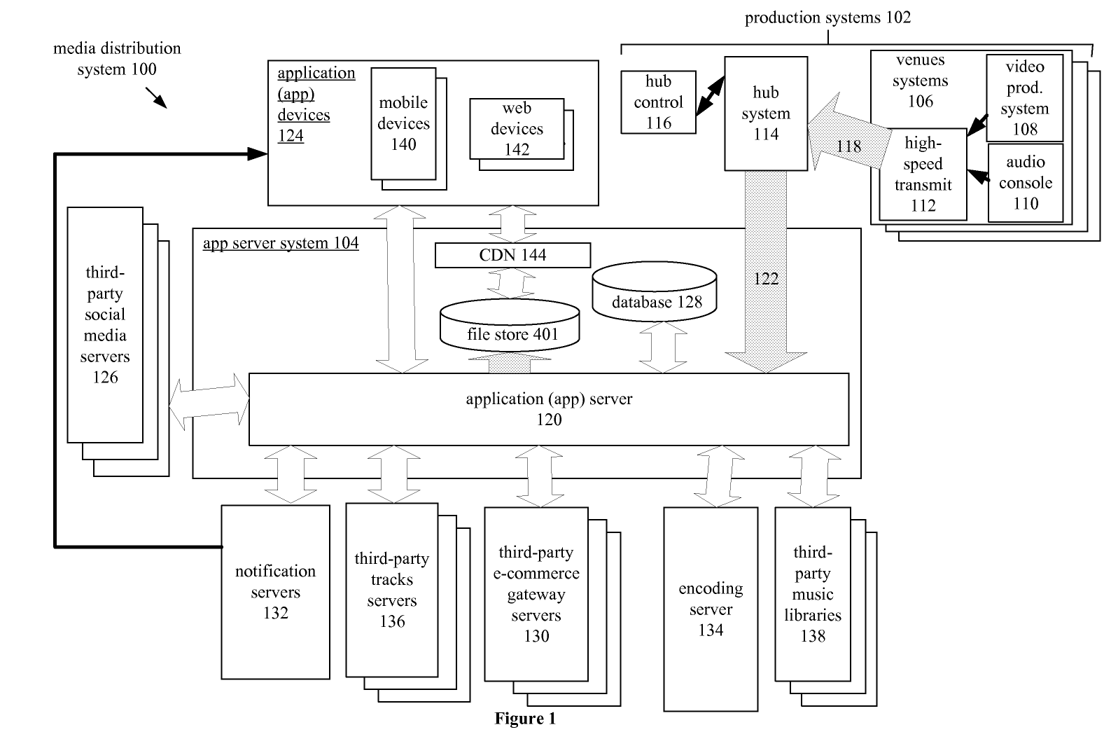

A media distribution system 100, as shown in FIG. 1, includes one or more production systems 102, at least one application (app) server system 104, and a plurality of user devices, which can be referred to as application (app) devices 124. The devices 124 can include mobile devices 140 (e.g., with built-in client apps) and web devices 142 (using web browsers). The devices 124 can include smart phones (e.g., Apple's iPhone, Android-based telephones or Windows-based mobile devices), tablet devices (e.g., Apple's iPad, Android-based tablets, etc.), desktop/laptop computers or an Internet-enabled TV devices, located at the live concert where the media segment is recorded, or located local to the live concert (e.g., in region with a common Internet connection to access the media data files), or located remotely from the live concert (e.g., anywhere with an Internet connection).

The media distribution system 100 can allow people with the devices 124 (referred to as “users”) who are interested in the live event, who may be attending the event (referred to as “punters”), to connect and interact with an event (e.g., a concert or gig), their friends at the event and their friends at home during the event. The users can view and listen to recorded segments of the live event while the event it still progressing and continuously thereafter, purchase the segments (e.g., the segments, which can be songs in a concert), recommend and share the segments (e.g., using messages, alerts, emails, and social media services), comment on the segments, rate the segments, and purchase merchandise relating to the segments or the event. The distribution system 100 can provide efficient distribution of the live segments recorded at the event to the users. The system 100 may provide an electronic forum for interacting with live music recordings, efficient and effective distribution of unique live music recordings in “real time”, and/or associated merchandise sales and distribution.

The system 100 can connect to social-media Web services, e.g., Facebook, Instagram, Twitter, etc., to enable exchange of social media data—e.g., data representing connections/links between users (also known as “friends”), data representing recommendations, data representing locations (“check-ins”), etc.—between the social-media sites and the system 100.

The system 100 can generate reports for administrators (e.g., artists, labels and event promoters) relating to the interaction of the users (e.g., punters at a concert) with recorded data from the event, including sharing and purchasing of different recorded segments of the event (e.g., representing live music purchases, preference, sentiment, social graphs, merchandise purchasing behaviour, location-specific data, conversations, etc.).

### Production Systems

The production systems 102 are configured to: record media segments, including segments, of live performances at a live concert; generate media data files representing respective ones of the recorded segments (including segments); and generate segment metadata (including segment metadata) representing a segment identifier (ID), e.g., a segment identifier (ID), for each recorded segment (e.g., recorded segment).

The production systems 102 include venue systems 106 at respective live event venues. Each venue system 106 includes a recoding system configured to record media segments (e.g., segments, which can be songs or other elements) of performances at a live event (e.g., a concert). The recording system is provided by at least portions of a video production system 108 and an audio production system 110 (also referred to as an audio console), e.g., including microphones and video cameras distributed around a concert venue. The venue system 106 also includes a high-speed transmitter 112 to transmit the recorded audio-visual (AV) data to a hub system 114 using a high-speed connection 118. The hub system 114—which may be referred to as a “studio”—receives the high-speed AV data from a plurality of venues systems 106, at a plurality of venues, and generates the media data files for the media distribution system 100. The hub system 114 is a form of “hub” surrounded by “spokes” in the form of high-speed data connections connecting to the plurality of venues. The hub system 114 is controlled by a hub control 116.

In embodiments, the video production system 108 can provide a live video feed of the live concert based on video input from a plurality of cameras in the venue, and production control from a live video production team. The front-of-house (FOH) audio console 110 can transmit live audio signals representing: a stereo band mix, a stereo audience mix, a mono lead vocalist line, and optionally stereo stems. A stem is a stereo file, commonly used in the context of multiple stereo files that combined together make up the mix of one song. By stripping down the audio segments and segments into stems—e.g., stereo drum segments, stereo guitar segments, stereo vocal segments, stereo keyboard segments, stereo crowd mix—the engineers in the hub system have more control over how the mix comes together, thus generating a higher-quality segment from the live performance. The high-speed transmitter 112 can be a commercially available unit, e.g., from Black Magic. The high-speed connection 118 can be one or more high-capacity (e.g., 10 Gb) Digital Video Network (DVN) lines, which may be available from a telecommunications provider, e.g., Telstra (in Australia).

The hub system 114 receives the raw media segment data (also referred to as audio-visual or AV data) through the high-speed connection 118, then processes (or “ingests”) the media segment data to generate the media data files. Processing the streams can include synchronising the different audio and video streams using commercially available recording AV modules and control by a sound engineer/production engineer who can provide manual inputs to adjust the automatic synchronisation if necessary (using the hub control 116). Thus the media segments include synchronised audio and video streams. The media segments can include the segments and non-segment segments (or non-song segments), e.g., in-between segment materials, spoken word, dances, audience activities, backstage antics, artist interviews, punter interviews, monologues between segments, spontaneous jams, etc.

The hub processing in the hub system 114 includes separating the raw AV data into individual the media segments, and improving the quality of the signals, e.g., using static-reduction, colour grading etc. In embodiments, the hub system 114 can include commercially available AV production servers, storage servers, encoding servers, and associated software packages, from “EVS Broadcast Equipment”, and/or “Avid Technology Inc.”. The hub control 116 can include corresponding control software and computing devices. The hub control 116 controls the processing in the hub system 114, e.g., to select start times and end times for the segments (in particular, the segments), to adjust quality, to adjust the sonic range and to enhance the visuals (colour grading, etc.) of the video content, etc.

The raw media data files may be too large for efficient storage and transmission to large numbers of app devices 124 at a concert; or different formats may be required for different types of app devices 124 and client apps: accordingly encoding and/or transcoding is generally provided by an encoding engine or component of the hub system 114 for encoding raw audio-visual (AV) files into one or more selected formats that can be played or rendered by the devices 124, e.g., the Moving Picture Experts Group Layer 3 (“MP3”) format for audio; commercially available lossless formats for audio; and the Moving Picture Experts Group 4 Part 14 (“MP4”) format for video. The encoding engine may be provided by a commercially available encoder, e.g., a Videocraft server. Alternatively, the encoding can be performed by an encoding server 134 on the raw data files after they are transferred to the server system 104, as described hereinafter.

The hub processing occurs in near-real time, thus providing data for the segment data files as they are being generated. The actual data files can be completed before sending them to the server system 104, or transmission to the server system 104 can commence before the end of the segment, i.e., portions of each segment or segment may be sent to the server system 104 for processing (further encoding, distribution, etc.) before the segment or segment is complete. Accordingly, it may be possible for a device 124 to receive a first portion of a segment file before the content of the segment has been generated, e.g., for longer segments, or segments requiring less production processing (e.g., vox pops or crowd footage).

The hub system 114 can include a preview generation component configured to generate preview data files representing previews of selected segments. The preview generation component can be provided by the commercially available encoder, e.g., the Videocraft server. The preview generation component can generate a preview media file by extracting/copying a selected portion of each media data file, e.g., a selected first “X” seconds a segment, where “X” is a number defined by the hub control 116. The preview files are encoded in the hub system 114 using the same formats as the media segments: once generated, the preview media files can be treated by the system 100 as additional media data files associated with the event.

The hub control 116 generates the metadata for the media files. The hub control 116 can generate a data event record representing each event. For a concert, the event record can represent: venues (e.g., including names and geospatial information for use by global positioning systems), dates, time, artists, a status (e.g., pre-show/live now/completed), set lists, segments played, segment status (e.g., “available”/“ready for purchase”), segment purchase cost, etc. The event records can include a plurality of segment records associated with segments, including: Size (i.e., data file size), Duration, Album Title, Artist Title, Event (reference), Artists (reference), Venue (reference), Compilation? (Yes/No), Number of Segments, Price, Release Date, List of Associated Segments, Type (e.g., audio, video, or AV). The concert data records can be referred to as “metadata” relating to the concert, and to the segments, where the media data files include the relevant “data”. The hub control 116 generates the segment identifier (ID) data for each segment. The segment ID can include: a unique identification code in the media distribution system 100; and media file location information (i.e., universal resource locator, URL, or equivalent) for the application (app) devices 124 to access the media data files from the file store 401 of the media distribution system 100.

The hub system 114 includes an audio-visual system (AVS) client (e.g., implemented as a native Microsoft Windows application, and executing on separate hardware) based on computer executable code that monitors the memory location of the generated media files (e.g., the encoded files or previews etc.), and uploads, transmits or publishes the completed media data files (including the preview files) to the server system 104 using another high-speed connection 122 (e.g., based on DVN lines).

### Application (App) Server System

As shown in FIG. 1, the server system 104 includes: an application (app) server 120, a database 128, a file store 401, and a content distribution network (CDN) 144.

Using a data network, the server 120 is in communication with the hub system 114, the database 128, the file store 401, the devices 124 and a plurality of external or third-party servers that are part of the media distribution system 100 including: third-party social media server 126, third-party e-commerce gateway servers 130, external notification servers 132, optionally an external encoding server 134, third-party tracks servers 136, and third-party music libraries 138. Each of the devices 124 includes an client application (or app), e.g., a mobile application, such as an iOS app. or an Android app., or a Web application accessed through a web browser, that communicates the app server 120.

Using a data network, the CDN 144 is in communication with the file store 401 and the client apps in the devices 124.

The database 128 stores user data, event data and the received segment metadata.

The stored event data is associated with future, present or past events for which media segments are to be generated, or are stored. The event data can include data representing information about the event, e.g., location, performer identifiers and names, segment (e.g., song) identifiers and titles, etc.

The stored metadata includes the metadata generated by the production systems 102. The stored metadata can also include data representing users who have registered or been authenticated for accessing the corresponding media data files (alternatively, the registered and authenticated users can be represented separately in the stored user data or other stored data in the database 128).

The stored user data is associated with registered/authenticated users in user data records with respective user identifiers (IDs). The stored user data can include: recommendation or rating data representing a subjective rating of the media data file received through the UI; sharing data representing transmission of data representing the segment ID to another user device; photograph data representing a photograph generated by the application and associated with the segment ID; and payment data representing a payment request associated with the segment ID.

The user records include user data received from the client apps due to interaction with the app device user interfaces (UIs) with the recorded segments. The user data can include: segment comments, segment ratings (or “likes”) associated with segment IDs, location data (e.g., check-ins), segment purchases associated with segment IDs (e.g., data representing a time, a value and a method/means of each purpose), merchandise purchases associated with segment IDs/venue IDs/artist IDs, etc., and links to other user records (e.g., “friends” with other authenticated client apps in the media distribution system 100). The user data can include ranking data, sharing data, photograph data, and payment data. The user data can represent the following, either available from a device 124 or from a third-party authentication service (described hereinafter) Email Address, Password, Social Network Credentials (e.g., Facebook Identifier), Name, Residential Address, Billing Details, Current Location (e.g., based on GPS data or a selected checkin), and Points/Badges Earned.

The file store 401 provides persistent file storage for the generated media data files representing the recorded segments. The CDN 144 provides access to the stored media data files in the file store 401 by the client apps.

In embodiments, the file store 401 can be a commercially available file store, e.g., the “S3” cloud storage from Amazon. In embodiments, the database 128 can include one or more linked databases accessed using structured query language (SQL) and based on a publicly available product from Oracle or an open-source product using PostgreSQL.

### Application Server

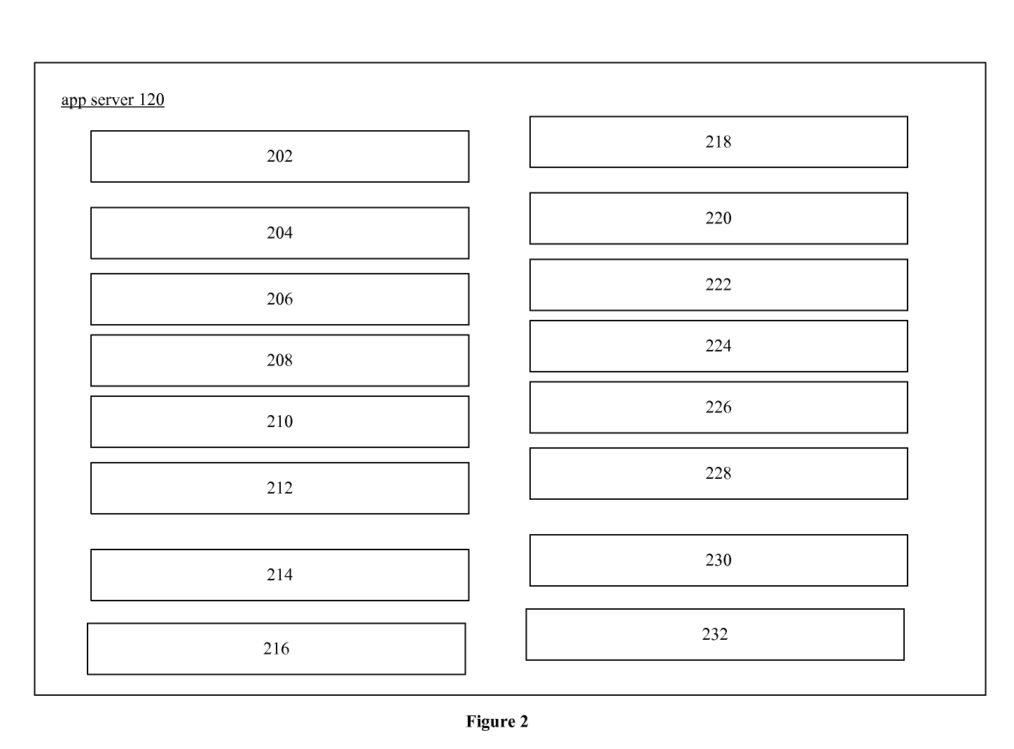

As shown in FIG. 2, the app server 120 includes a plurality of components (which can also be referred to as modules), including:
an application programming interface (API) component 202
at least one audio-visual system (AVS) server component 204;
a content management system (CMS) 206;
at least one tracking component, including a user activity monitoring component 208, a purchasing engine 210, and one or more e-commerce connectors 212;
a delivery component 214;
a merchandising component 216;
an authentication component 218;
at least one an alerting component, including a recommendation engine 220, an activity feed generation component 222, an in-app notification connector 224, and a push notification connector 226;
a nearby engine 228;
a report capture and analysis engine 230; and
a gamification component 232.

The API component 202 recognises requests or calls from the other servers, systems and devices in the media distribution system 100 with which the app server 120 communicates. The API component 202 authenticates any requests (e.g., using secure sockets layer/SSL authentication) and provides responses from the other components in the app server 120.

The AVS server component 204 is configured to communicate with the AVS client in the hub system 114 to receive the media data files and respective segment metadata from the production system. The AVS server component 204 is configured to store the media data files in a file store 401, and store the segment metadata in a database 128. The metadata includes segment identifiers (IDs) corresponding to the received media data files and file locators (e.g., pointers or universal resource locators) that point to the media data file locations. The AVS server component 204 is configured to send update data to the recommendation engine 220 when new segments are available, as described in more detail hereinafter.

The CMS 206 is configured to communicate with the devices 124, including administrator or artist devices, using the API component 202, to receive metadata for storage in the database 128, e.g., upcoming concert dates that may be announced to interested users. The CMS 206 is configured to send update data to the recommendation engine 220 when data is entered.

The at least one tracking component is configured to receive user response data, generated by the client application of the user device, representing the segment ID and a response from the user associated with the corresponding segment. The at least one tracking component is configured to store the user response data in the database 128 in association with the segment ID.

The user activity monitoring component 208 is configured to receive user activity data representing user activity from the devices 124 via the API component 202. The user activity data is generated based on user input received by the devices 124 and can include: (i) ratings data representing a subjective rating (e.g., a like/dislike, or star rating, a ranking, etc.) of the media data file received through the UI; and (ii) sharing data representing transmission of data representing the segment ID to another user device (e.g., sharing a reference to or a title of a track with a friend at a concert). The user activity monitoring component 208 stores the user activity data in the database 128 in association with each user's ID/data record.

The user activity monitoring component 208 is configured to transmit updates to the recommendation engine 220 and/or the activity feed generation component 222, if user response data is received, so that the alerting components can generate alerts data for other user devices 124 and/or third-party social-networking servers. The user response data can represent feedback from the user and can be used by the app server 120 to provide social interaction with and around the live event.

The purchasing engine 210 is configured to process the payment data in the user response data representing a payment request to fulfil the payment request. The purchasing engine 210 is configured to allow a user to purchase segments from the file store 401, or from the third-party tracks servers 136 (e.g., Apple Inc's “iTunes” store), using the UI of the client app. The UI is configured to send payment data in association with a segment ID to the purchasing engine 210 representing a payment request. Upon receipt of this payment data and the segment ID, the purchasing engine 210 processes the payment data to fulfil the payment request, and authorises the delivery component 214 to send a link to the media data file corresponding to the segment ID in the user data to the user device 124. The purchasing engine 210 can process the payment data, to confirm a payment, using the plurality of e-commerce connectors 212 to the respective third-party e-commerce servers 130, e.g., provided by a bank or credit card company (e.g., VISA or Mastercard), Google Inc's “Wallet” service, or PayPal's service. The e-commerce connectors 212 are configured to receive payment approval data from an e-commerce server when the purchasing engine is processing the payment data. The third-party e-commerce servers 130 may process the payments, and generate payment approval data for the purchasing engine 210, based on additional input from the user of the app device 124 (e.g., credit card details), or based on stored user data (e.g., credit card details stored in the user record, or accessed from the third-party social media servers using the user's authentication details in the user record). Alternatively, the purchasing engine 210 can process the payment data using an e-commerce connector 212 that connects directly to a financial institution, e.g., a direct debit service provided by a bank or a credit union or a building society.

The purchasing engine 210 can receive and process pre-order data from the client app representing pre-orders of segments associated with future concerts available in the database 128. After receiving the pre-order data, the purchasing engine 210 stores the pre-order data in the appropriate user data for use in alerting the user when the pre-ordered segment(s) are available. The pre-order can include a pre-payment which is performed using similar steps to the standard ordering process.

The delivery component 214 (also referred to as a distribution component) is configured to send delivery data to the client application following processing of the payment data to allow the client application to access the media data file corresponding to the segment ID. The delivery data can be an encoded version of the media data file, e.g., transmitted directly to the client app., or using a third-party mail server. Alternatively, the delivery data can be a link or locator to allow the permitted device 124 to access the media data file via the CDN 144. The link (a URL or equivalent) can be accessed in the metadata in the database 128.

The merchandising component 216 is configured to send merchandise data to the client application representing one or more merchandise items associated with the live concert. The user response data can include payment data represents a selected one of the merchandise items. The merchandise items can include products or goods associated with the event, e.g., T-shirts or hats. The merchandising component 216 is configured to generate receipt data for the client app for use in collecting a purchased merchandise item, e.g., a code for display to a vendor. Alternatively, the merchandising component 216 can send data based on the user data to a shipping server (e.g., at a warehouse), which can be used to generate delivery instructions for shipping a purchased merchandise item to the purchasing user.

The authentication component 218 is configured to receive authentication permission data from the devices 124 representing permission for the authentication component 218 to access third-party user profile data in a third-party authentication server associated with the user data, and to store the third-party user profile data in the user data. For example, the authentication component 218 can be configured with the Login-With-Facebook Software Development Kit (SDK) and, when given Facebook access permission data by the device 124, can access a corresponding user's Facebook profile (and thus Facebook user profile data) in a remote Facebook authentication server system accessed via the API component 202. Accessing to the third-party user profile data can allow the user to populate their user data record without manually re-entering all the relevant data, e.g., music preferences, events attended, events to be attended, identification details of friends and contacts, and personal profile information.

The alerting component is configured to determine if one of the recorded media segments is associated with a user based on the stored metadata and corresponding user data stored in the database, and if so generating alert data for a client application in a user device associated with the user in the user data, wherein alert data generates an alert in a user interface (UI) of the user device. The alert may indicate that a segment may be of interest to a user based on their preferences, location, or friends recommendations. The alerting component can be configured to transmit the segment ID to at least one of the app devices 124 (which can be at the live event, local to the live event, or remote from the live event) to notify or trigger a user interface (UI) of the device 124, and receive user data (also referred to as “user response data”) generated by the user device 124 representing input from the user interface of the user device relating to the segment ID, and the segment ID itself.

The recommendation engine 220 is scheduled regularly to access the metadata associated with segments (e.g., metadata about an event), and the user data associated with a selected user and user data of that user's friends and contacts, in the database 128 to generate recommendations for the selected user's client app. The recommendation engine 220 can periodically (or regularly or according to a schedule) generate alert data representing recommendations for the selected user based on their preferences and selection rules (e.g., send updates to all users who are attending, or are registered to attend, a selected event). The recommendations are generated based on: (i) alerts received from other components; (ii) user and event data in the database 128; and (iii) recommendation rules, stored in the database 128, that can be configured by a system administrator to determine when and to whom selected recommendations are sent. For example, the recommendation rule could specify that recommendations relating to a selected event are only sent to user devices that have already purchased a segment for that event.

The activity feed generation component 222 is configured to generate and send activity feed data associated with a live event to the client application of the user if the user is associated with the live event in the stored user data in the database. For example, the association can be based on data in the database representing a location of the live event and the stored location data from the nearby engine 228. The association can be based on data representing a current location or a recommendation (in rating data) of a friend of the user (recorded in the user's data record). The activity feed data can represent stored user data of other friend users who are represented in the stored user data of the user. The activity feed generation component 222 is configured to is configured to generate and send activity feed data for each entity to each client app with subscription criteria (in the stored user data) that match that entity ID, e.g., representing actions recorded in the database 128 for that entity. For example, an artist can use an authenticated connection to the database 128 via an client app on one of the app devices 124 to post content, e.g., including audio, video, text and images, which are recorded as segment data files in the database 128 together with the segment media data files (or optionally in the file store 401 linked to records in the database 128), and are indexed using segment IDs (equivalent to segment IDs) in the database 128. For example, certain artists with appropriate login credentials can send data representing “posts”, or short publications, including audio, video, text and images, which the activity feed generation component 222 sends to each client app based on the respective subscription criteria or conditions of the client apps (e.g., an example client app can have a selection in its corresponding user record to receive any posts from a selected artist, venue or event). The segment IDs can be sent to the client apps by the activity feed generation component 222, e.g., based on the user criteria, or based on sharing of the segment IDs between different ones of the client apps, or from sharing data from the third-party social media servers 126. The segment IDs can be used to retrieve links to the segment files in the file store 401 for viewing, downloading and storing on the app devices 124. Selected segments may be sent to the client apps without any processing of payment data, thus allowing cost-free promotion and sharing of an event using the non-segment segments.

The activity feed generation component 222 is configured to generate and send activity feed data associated with a live event to a third-party social media server if the user is associated with the live event in the stored user data in the database. The activity feed generation component 222 can transmit to the third-party social media servers 126 (e.g., commercially available systems from Facebook, Instagram, Twitter, Google and Foursquare, etc.) directly, or via a social media connector (SMC). The social media connector (SMC) is a module that connects activity feed generation component 222 to the application program interfaces (APIs) of the social media services (e.g., Facebook, etc.) in the social media servers 126. For example, the SMC can transmit data for authentication, posting, rendering and generation of a Facebook Open Graph Canvas app. The SMC can connect using proprietary protocols (e.g., Facebook's Open Graph protocol, the Twitter protocol, etc.) to transmit data representing actions to the third-party social media servers 126, e.g., for use in Facebook's “ticker”, “timeline” and “news feed” processes, or for additional to user information (such as a profile picture). The actions may include any one or more of: buying a segment or concert, pre-purchasing a concert, exclusive artist content, check-ins, badges earned, rewards earned, dedications, photos & comments, and liking/rating a moment within a segment. he shared actions can be shown in the UI in the client app, e.g., between client apps that are linked (e.g., as “friends”) in the user records data, including recommendations (“likes”) and location indicators (“check-ins”). Each client app can generate filtering criteria to receive or display only selected shared actions, e.g., based on their own locations (e.g., criteria selecting only shared actions for client apps associated with the same location, or venue, or concert).

The recommendation engine 220 and the activity feed generation engine 222 are configured to generate and send notifications to the client apps for segments with metadata corresponding to subscription criteria in the stored user data. Each user account includes subscription data indicating which types of segments each user wishes to receive. The recorded criteria in the subscription data can include any one or more of: an artist ID; a concert series ID (e.g., regular gigs and festivals); and a venue ID. The recommendation engine 220 and the activity feed generation engine 222 can control sending of the notifications based on: (i) location data from the app devices 124 (e.g., due to one of the app devices 124 coming into close proximity of a venue, and using a global position system or an Internet-protocol address of the device 124), and/or (ii) response data from the app devices 124, or from the social-media servers 126, based on a user input indicating a link to a venue (e.g., “checking in” using the client app or using a third-party social media client).

The alerting components can use the notification connectors 224,226 which are configured to transmit notification data to the client apps. The notification data can be used by the devices 123 to generate notifications in user interfaces (Us) of the user devices. The notification connectors 224,226 configured to connect to the one or more notification servers 132 to send notification data to the devices 124 when the alerting components generate update or notification data for the devices 124: for example, the recommendation engine 220 can generate a recommendation if the AVS server component 204 generates an update representing that new media data files are available in the file store 401; or the recommendation engine 220 can generate a recommendation based on user profiles in the database 128 and recommendation rules. The device 124 can generate a notification in a user interface (UI) of the device, e.g., an alert in a device (to alert the user), or an alert icon (e.g., a red button in an iOS app), or inclusion of a new-segment indicator in a list of alerts, etc.

The notification connectors 224,226 can be configured to communicate with commercially available servers that send notifications: in-app notification connector 224 can connect to a third-party library (e.g., Pubnub or Pusher) that provides a stream of update data to the devices 124; and the push notification connector 226 can connect to an third-party service associated with the operating systems on the devices 124 (e.g., Apple's “Apple Push Notification Service” for iPhones, or an equivalent service by Google for Android telephones).

The nearby engine 228 is configured to receive location data representing locations of user devices and store the location data in the stored user data in association with user identifiers of the user devices. The nearby engine 228 can send corresponding data to the recommendation engine 220 and the activity feed generation engine 222 for potential distribution based on business rules and the subscription criteria (e.g., which updates should be posted). The location data can be used to provide location-based updates by the activity feed generation engine 222 (e.g., to push notifications or update data associated with friends or concerts nearby).

The report capture and analysis engine 230 is configured to generate report data for access by administrator clients which connect and authenticate with the app server 120. The report data can include: trending data representing time-based popularity (e.g., based a determined number of share actions, or ratings actions, etc.) of the media segments (i.e., the segments and/or the non-segment segments); and charting data representing a determined number of the purchases of each segment for selected units of time (e.g., by minute, hourly, daily, weekly, etc.) based on stored payment data in the database 128 which is generated by the purchasing engine 210 when processing the payment data.

The gamification component 232 is configured to generate and store game data recording “awards” or “badges” for actions performed by the client apps, e.g., purchases of segments for selected artists/gigs/venues, rating of segments, sharing of segments, etc. The gamification component 232 can adjust a user record or account if the awards reach a pre-selected level, e.g., a high scores can result in a user rewards such as free segments. The game data can allow the client apps to play games where points are accrued for the above actions.

The components of the app server 120 can be built using known languages and tools, e.g., Django, Python, Java, compiled binaries and/or the PHP hypertext preprocessor. The API component 202 can be based on Representational State Transfer (REST) using JavaScript Object Notation (JSON) as the transfer mechanism. The boundaries between the components in the in the app server 120 are exemplary, and alternative embodiments may merge components or impose an alternative decomposition of functionality of components. For example, the components discussed herein may be decomposed into subcomponents to be executed as multiple computer processes, and, optionally, on multiple computers. Moreover, alternative embodiments may combine multiple instances of a particular components or subcomponent. Furthermore, the operations of the components may be combined or the functionality of the operations may be distributed in additional operations. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like. The processes provided by the components may be embodied in a machine-readable and/or computer-readable medium for configuring a computer system to execute the described processes. The components may be stored within and/or transmitted to non-transitory computer system memory as computer-readable instructions to configure the computer system to perform the functions of the components. The computer systems can process the computer-readable instructions (a list of internally stored instructions such as a particular application program and/or an operating system) and produce resultant output information via input/output (I/O) devices.

### File Store and Content Delivery Network

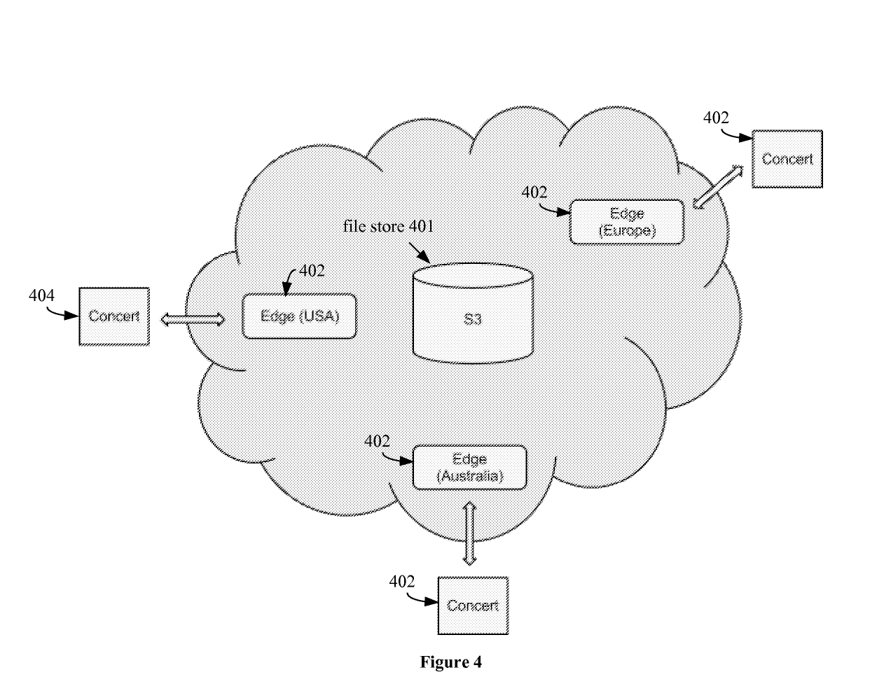

The CDN is configured to receive high-volume requests for the media data files, and high-volume transmissions of the user data, from the app devices 124, and to transmit the requested media file at high speed to the app devices 124, e.g., in substantially less time than the duration of the segment represented by the data file. The CDN 144 can include edge servers 402 (e.g., Amazon.com, Inc's “Cloudfront” servers) close to each live concert 404, as shown in FIG. 4. The file store 401 can include a commercially available cloud storage system, e.g., Amazon.com, Inc's “S3” storage system.

The media data files are generally available for downloading or transfer as complete files to the app devices 124; however, delivery component 214 can stream portions of the media data files, e.g., as low resolution, to allow the app devices to display “previews” of the segments without requiring a payment and file transfer. For example, an app device 124 may be able to download and/or stream a portion (e.g., with a duration of a selected number of seconds) of any of the segments for sale. The preview can be streamed for immediate playback without download.

Although the media data files can be streamed from the CDN 144, since the files are stored as complete mastered files before download commences, the transmission speed of the media data file to the user device can be independent of a duration of the corresponding segment: this is in contrast to a live streaming feed, e.g., of a live sporting event or live on television.

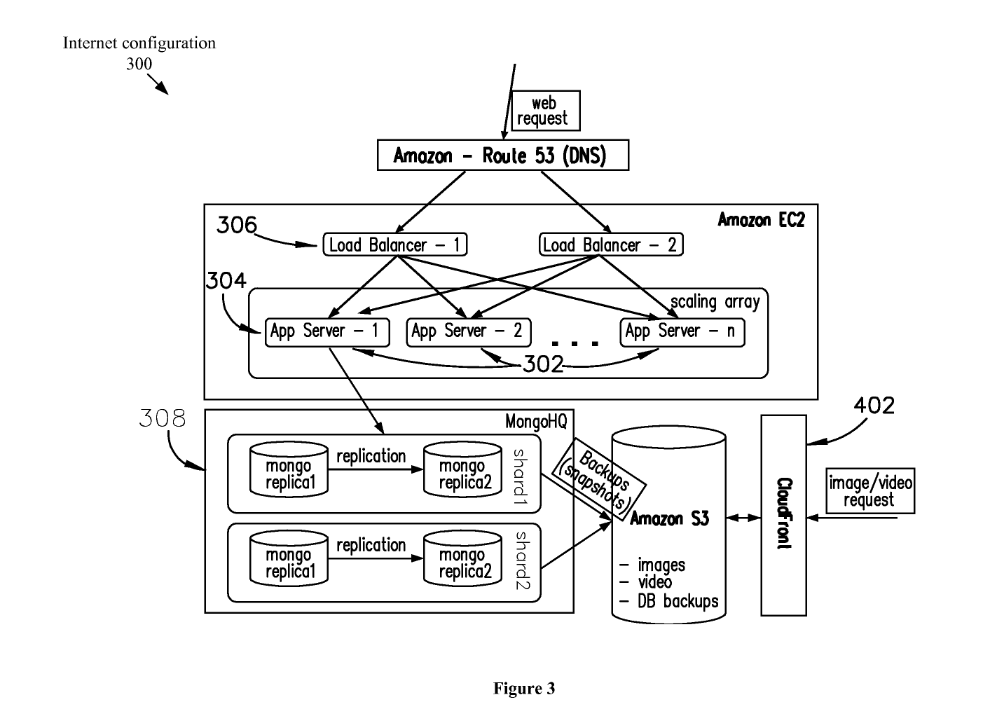

In embodiments, as shown in FIG. 3, the app server 120 includes a plurality of parallel app servers 302 in a scaling array 304. Requests from the client apps are received by load balancers 306 (e.g., commercially available units) that distribute the requests to the parallel app servers 302. The CMS data (i.e., the segment records, the user records, etc.) are stored in a plurality of commercially available replicated databases 308 (e.g., from MongoDB).

### App Devices

The client app includes: (i) a UI for the user of the app device 124; (ii) a data model (including persistent and non-persistent storage, and a local database); and (iii) a controller configured to communicate with the API component 202. The UI can be an iOS app for an Apple iPhone or an Apple iPad, or an Android app for an Android device (e.g., from Samsung), or an app for the BlackBerry, Windows Phone, or Nokia Symbian operating systems. Alternatively, the client app can be for a notebook or desktop operating system, such as Microsoft's “Windows”, Apple Inc's “OSX”, or “Linux”, or for operating in a browser, such as Microsoft's “Internet Explorer”, Google's “Chrome”, or Apple's “Safari”. The app server 120 can transmit user interface data based on the HTML5 and CSS3 formats for the web devices.

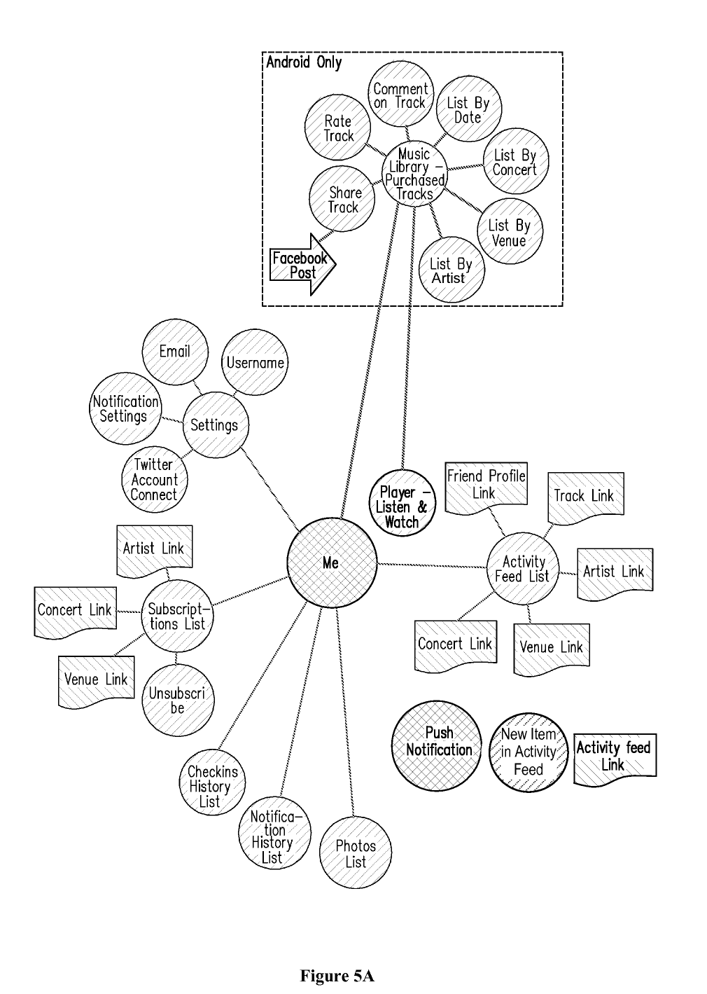

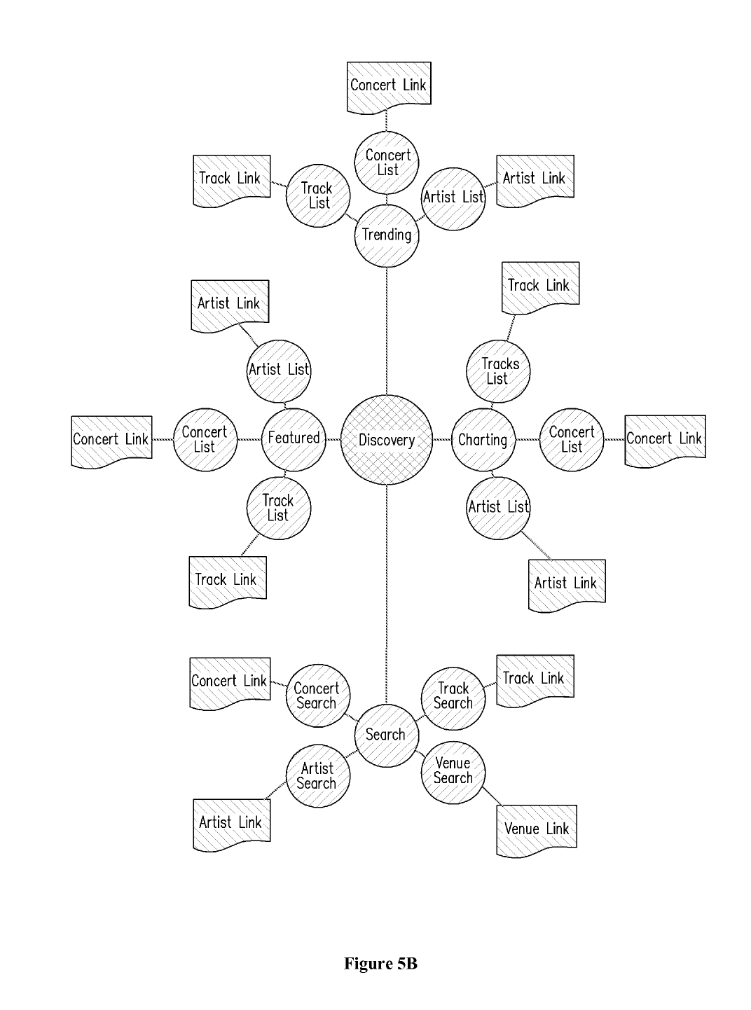

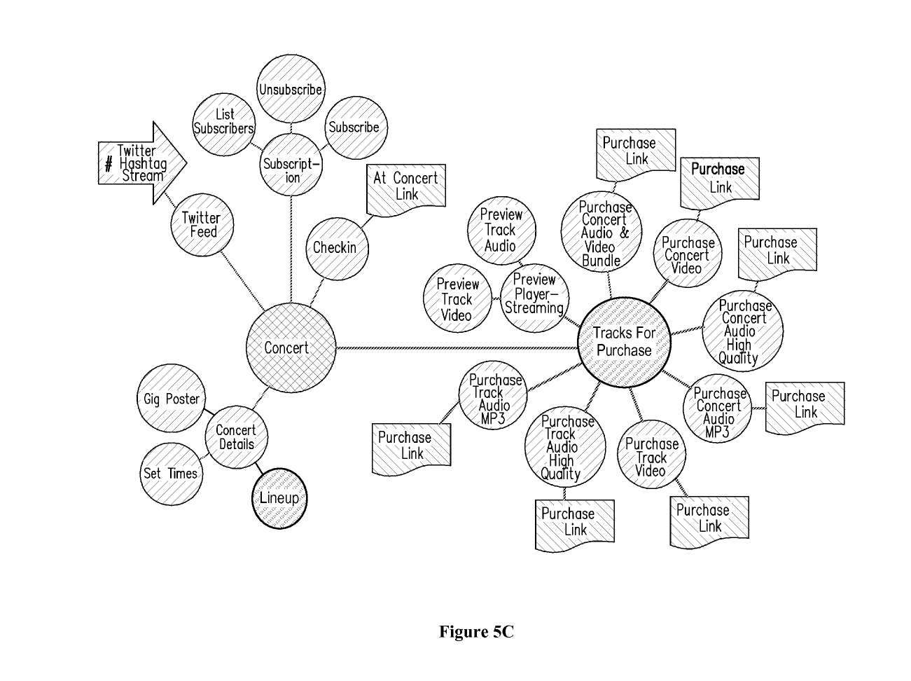

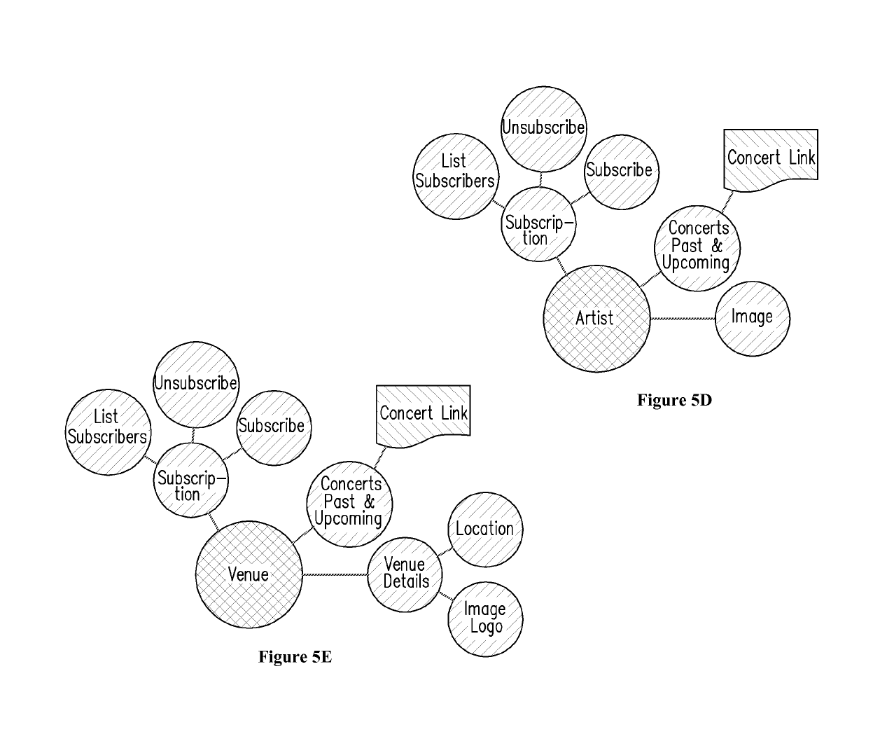

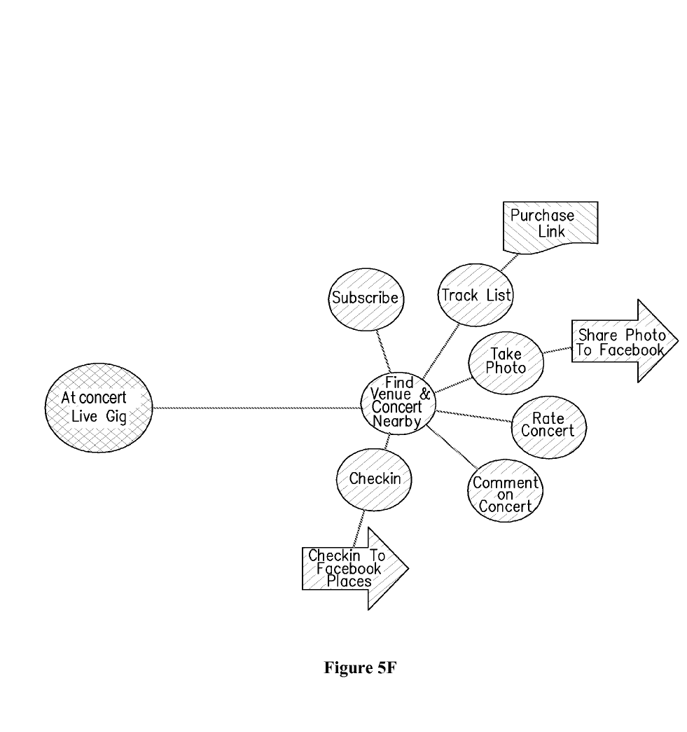

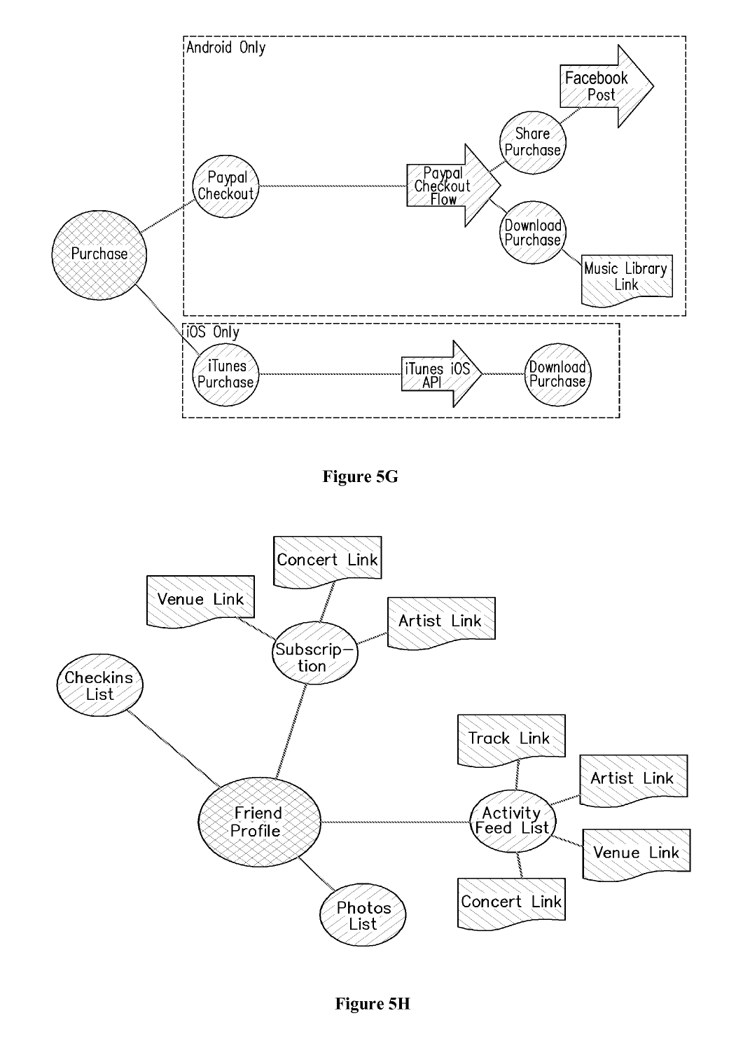

As shown in FIGS. 5A-5H, the UI generates data for the user to perform the following actions:
search available segments and listed future concerts in the database 128;
discover music by searching for: artists, segments, venues, concerts, gigs & festivals;
nearby venues and upcoming concerts based on current location;
view the following information about a concert, based on the metadata and data from the SMC: a lineup of artists, timetables, other users subscribed, other users checked in at the venue, Twitter and Instagram hashtag feeds;
view the following information about a venue, based on the metadata and data from the SMC: location, history of concerts, upcoming concerts, users subscribed, seating maps/festival maps;
view the following information about an artist, based on the metadata and data from the SMC: exclusive content (video/audio/images/text), a history of concerts, upcoming concerts, and users subscribed;
view a feed of activity including: segments (audio/video) available for purchase, upcoming concerts added to a venue, upcoming concerts added by an artist optionally filtered by area, exclusive artist content as it is added, linked friends activity, friends joining, friends' purchases, friends' check-ins, friends' ratings and comments, friends' photos shared using one of the client apps, and friends' badges and rewards earned;
view recommendations including: trending and charting segments (based on the metadata), featured artists and segments, user recommendations; and
receive in-app notifications, and alerts of email notifications.

### Synchronization of Segment Data

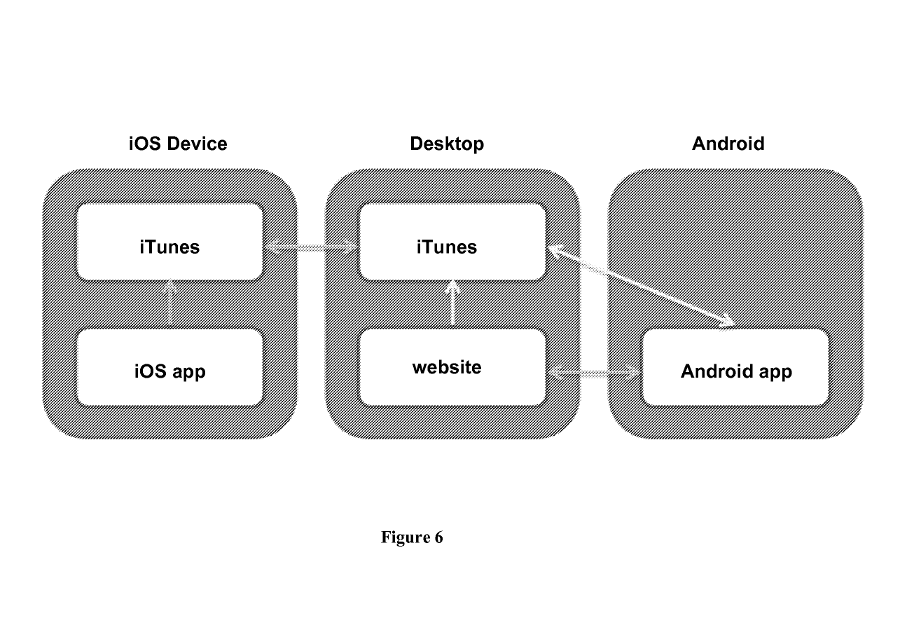

FIG. 6 shows how a user can access their media data files across different app devices 124 and platforms. The orange arrows indicate music purchases that will be automatically synchronised, either by the app server 120 or by a third-party segments server 136. The white arrows indicate music that a user will be required to synchronise manually. For iOS users, purchases made using the web devices and an Android app will be able to be manually imported into the iTunes desktop app and then synchronized to the user's mobile device via iTunes. For Android users, purchases made on the iTunes desktop may be manually exported to MP3 or MP4 and then synchronized to the device.

### Media Distribution Process

A media distribution process provided by the system 100 includes the following steps:
metadata relating to a pending musical event are transmitted to the database 128 by an administrator, e.g., a person organising the event;
during the event, AV media file are recorded and initially processed in the venue system 106 at the venue of the event;
the raw files are transmitted from the venue system 106 to the centralised hub system 114;
the raw files are transcoded (and previews generated) in the hub system 114, each in a plurality of formats (e.g., for use across a range of iOS, Android and Tablet devices) to generate the media files;
respective media metadata, including size, length, format and storage location, are generated in the hub control 116 and the hub system 114;
the media files are transmitted from the AVS client to the AVS server component 204 which stores them in the file store 401;
the media metadata are transmitted from the AVS client to the AVS server component 204 and/or the CMS 206, which stores them in the database 128;
the CDN 144 pushes selected copies of the stored files from the file store 401 to edge servers 402 at physical locations close to the venue;
the AVS server component 204 generates an update for the recommendation engine 220 that the media files are available in the file store 401;
the recommendation engine 220 uses the notification connectors 224,226 to direct the notification servers 132 to notify selected users, based on their selection criteria in their user records, of each segment's availability;
the client apps in the app devices 124 indicate the notifications to the users using their respective UIs;
the client app UI generates a display of available segment, e.g., using the segment name, etc., received with the notification (or optionally, accessed from the database 128 using a segment ID received with the alert data)
the client app UI receives user data representing a selection of the segment for purchase or trial;
the client app UI accesses payment data, which may be input by the user, or stored in the app device, or stored in the stored user data in the database 128, or stored in a third-party account which is authenticated using credentials accessed by the app server 120 (e.g., a Facebook, PayPal or iTunes account);
on receipt of the payment data, the purchasing engine 210 checks with the e-commerce connector 212, checks the format for this client app, generates and secures a locator (e.g., a URL) based on the authentication data for this user in the database 128, and uses the delivery component 214 to send to the client app a link (e.g., a secured unique URL) that allows the client app to download the media data file with a transcoding format corresponding to that client app (e.g., based on the client app's operating system or device) via the CDN 144;
the client app downloads the selected media data file to local storage on the app device for playback using the app UI and/or at least partially streams the file; and
the client app receives further user data generated by the device 124 representing the segment ID and input from the user interface of the device 124 relating to the segment ID representing feedback from the user, e.g., a recommendation associate with the segment ID that is sent to the user activity monitoring component 208.

### Alternative Embodiments

In some embodiments, the media data files from the hub system 114 may require encoding or transcoding (or additional encoding or transcoding). The media distribution system 100 can provide for this transcoding by sending media files to an encoding server 134, e.g., a commercially available server from “Encoding.com”, and receiving and storing the transcoded media data files, which may have each segment in a plurality of different encoding formats (e.g., MP3 and OGG), in the file store 401.

In some embodiments, the media data files and their associated metadata may be transmitted to a third-party segments server (e.g., a commercially available system, such as Apple Inc's “iTunes Publishing Service”) for purchase and/or access by the app devices. The notifications from the notification servers can instruct the client app UI to indicate that the segments are available in the third-part segments server.

In some embodiments, the system 100 may configured for use in distributing segments of live events that are not concerts, e.g., live sporting events, conferences, dramatic plays, dance productions, operas, comedy acts, etc. In these embodiments, the “performances” corresponding to the “segments” can sub-events in each event. For example, a sporting event, a “sub-event” may be significant portions of the game, e.g., halves, quarters, rounds, games in tennis, shots in golf, balls or overs in cricket, pitches in baseball, etc. selected based on pre-determined criteria in the hub control. For a conference, the sub-events may be talks, lectures or sessions. For theatre or dance production, the sub-events can be acts or scene. For a comedy act, the sub-events could be sketches, jokes or artists.

In embodiments, the components and modules of the production system 102 and the server components 104 may be exchanged or shared. For example, in embodiments, the preview segments may be generated in the sub system before upload to the CMS 206; or the transcoding and notification generation may be provided by computing machines in the hub system. Thus the divisions between the productions systems 102 and the server components 104 may be changeable. In embodiments, the production systems 102 can include proprietary hardware located in private premises, and the server components 104 can be “cloud” components located in commercially available hardware installations.

In some embodiments, the client app may connect to third party music libraries 138 (e.g., Spotify, Rdio, Last.fm, etc.) via the app server 120 and a connected music library connector 144 in the server components 104. The third-party music libraries 138 can provide data for music discovery by the client app, e.g., to determine what other music is available for an artist represented in the event record (in the databases 400) for a received segment ID in the client app.

In some embodiments, the media distribution system may include one or more production systems and one or more server components configured to: record media segments of performances at a live event; generate media data files representing respective ones of the recorded segments; generate segment metadata representing a segment identifier (ID) for each recorded segment; receive at least one of the media data files from the production systems; receive the segment ID corresponding to the received media data file; transmit the segment ID to at least one application device to generate a notification in a user interface (UI) of the device; and receive user data generated by the application device representing the segment ID and input from the user interface of the application device relating to the segment ID.

In some embodiments, the user data may include any one or more of: rating data representing a subjective rating of the media data file received through the UI; sharing data representing transmission of data representing the segment ID to another application device; photograph data representing a photograph generated by the application and associated with the segment ID; and payment data representing a payment request associated with the segment ID. The user data may include payment data representing a payment request, and the system can be configured to: process the payment data to fulfil the payment request; and send the media data file corresponding to the segment ID in the user data to the application device following processing of the payment data. Processing the payment data may include receiving payment approval data from an e-commerce server.

In some embodiments, the one or more server components may be configured to send merchandise data to the application device representing one or more merchandise items associated with the live concert, and the payment data can represent a selected one of the merchandise items. The server components may be configured to transmit the media data file to the application device. The server components may be configured to receive purchase data corresponding to the segment ID. The server components may be configured to, send and receive data using user authentication data access from third-party social media systems. The server components may be configured to receive media metadata associated with segment IDs. The server components may be configured to receive user profile data representing selection criteria from a user. The server components may be configured to transmit the user data to other application devices and/or third-party social media systems. The server components may be configured to receive data representing a current location of the application device, and to select a segment based on the current location. The server components may be configured to receive data representing a friend's current location of a different application device associated with a friend in a user record of the user, and to select a segment based on the current location. The server components may be configured to receive data representing a friend recommendation from a different application device associated with a friend in a user record of the user, and to select a segment based on the friend recommendation. The server components may be configured to share the user data with other application devices identified in a user record of the application device or the user.

In some embodiments, the media distribution process may include the steps of: recording media segments of performances at a live concert; generating media data files representing respective ones of the recorded segments; generating segment metadata representing a segment identifier (ID) for each recorded segment; transmitting the segment ID to at least one application device to activate a user interface (UI) of the device; and receiving user data generated by the application device representing the segment ID and input from the user interface of the application device relating to the segment ID. Processing the payment data may include receiving payment approval data from an e-commerce server.

In some embodiments, the media distribution process may include the steps of: recording media segments of performances at a live event; generating media data files representing respective ones of the recorded segments; generating segment metadata representing a segment record for recorded segment; selecting at least one from a plurality application clients, represented by user record data, based on selection criteria in the user record data matching data in the segment record; and sending data representing the media data file to the selected application client. The process may also include the steps of: sending data to the application device representing a segment ID identifying the selected segment; and receiving input from the user interface of the application device relating to the segment ID.

In some embodiments, the system is configured to perform the steps of any one of the above processes.

### Interpretation

Many modifications will be apparent to those skilled in the art without departing from the scope of the present invention.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

I/We claim:

1. A system including:
a recording system configured to record media segments of performances at a live event;
a production system configured to generate:
media data files representing respective ones of the recorded segments, and
segment metadata associated with the respective recorded segments;
a server component configured to:
receive the media data files and the respective segment metadata from the production system,
store the media data files in a file store, and
store the segment metadata in a database;
an alerting component configured to determine if one of the recorded media segments is associated with a user based on the stored metadata and corresponding user data associated with the user, and generate alert data, representing the associated segment, for a client application in a user device associated with the user in the user data, wherein alert data generates an alert in a user interface (UI) of the user device; and
a tracking component configured to receive user response data, generated by the client application, representing a segment ID to identify the associated segment and a response from the user associated with the associated segment.

2. The system of claim 1, including a delivery component configured to send delivery data to the client application to allow the client application to access the media data file corresponding to the segment ID.

3. The system of claim 2, wherein the user response data include payment data representing a payment request associated with the segment ID, and the tracking component includes a purchasing engine configured to process the payment data to fulfil the payment request; and the delivery component is configured to send the delivery data only if the purchasing engine generates data indicating that the payment request has been fulfilled.

4. The system of claim 3, wherein the purchasing engine includes an e-commerce connector configured to receive payment approval data from an e-commerce server that the payment request has been fulfilled.

5. The system of claim 1, wherein the user response data include payment data representing a payment request associated with the segment ID, and the tracking component includes a purchasing engine configured to process the payment data to fulfil the payment request; and the system includes a merchandising component configured to send merchandise data to the client application representing one or more merchandise items associated with the live event, and the payment data represent a selected one of the merchandise items.

6. The system of claim 1, wherein the tracking component includes a user activity monitoring component configured to store at least a portion of the user response data in the database in association with the segment ID.

7. The system of claim 6, wherein the user response data include ratings data representing a subjective rating of the media data file received through the UI.

8. The system of claim 6, wherein the user response data include sharing data representing transmission of data representing the media data file from the user device to a different user device.

9. The system of claim 6, wherein the user response data include photograph data representing a photograph generated by the client application.

10. The system of claim 1, including an authentication component configured to receive authentication permission data from the client application representing permission for the authentication component to access third-party user profile data in a third-party authentication server associated with the user data, and to store the third-party user profile data in the user data.

11. The system of claim 1, wherein the alerting component includes an activity feed generation component configured to generate and send activity feed data associated with the live event to the client application of the user if the user is associated with the live event in the stored user data in the database.

12. The system of claim 11, wherein the activity feed data represent stored user data of other friend users who are represented in the stored user data of the user.

13. The system of claim 1, wherein the alerting component includes an activity feed generation component configured to generate and send activity feed data associated with a live event to a third-party social media server if the user is associated with the live event in the stored user data in the database.

14. The system of claim 1, including a nearby engine configured to receive location data representing locations of user devices and store the location data in the stored user data in association with user identifiers of the user devices.

15. The system of claim 14, wherein the alerting component includes an activity feed generation component configured to generate and send activity feed data associated with the live event to the client application of the user if the user is associated with the live event in the stored user data in the database, wherein the association is based on data in the database representing a location of the live event and the stored location data from the nearby engine.

16. The system of claim 1, wherein the transmission speed of the media data file to the user device is independent of a duration of the corresponding segment.

17. A process, including the steps of:
recording media segments of performances at a live event;
generating media data files representing respective ones of the recorded segments;
generating segment metadata associated with the respective recorded segments;
determining if one of the recorded media segments is associated with a user based on metadata and corresponding user data associated with the user;
generating alert data, representing the associated segment, for a client application in a user device to generate an alert in a user interface (UI) of the user device, and
receiving user response data generated by the client application representing a segment ID to identify the associated segment and a response from the user associated with the associated segment.

18. The process of claim 17, wherein the user response data include payment data representing a payment request, and the process includes the steps of:
processing the payment data to fulfil the payment request; and
sending delivery data to the client application to access the media data file corresponding to the segment ID.

19. The process of claim 18, wherein the step of processing the payment data includes receiving payment approval data from an e-commerce server.

20. A media distribution process, including the steps of:
recording media segments of performances at a live event;
generating media data files representing respective ones of the recorded segments;
generating segment metadata representing a segment record for recorded segment;
selecting at least one from a plurality application clients, represented by user record data, based on selection criteria in the user record data matching data in the segment record; and
sending data representing the media data file to the selected application client.
